(19) United States
(12) Patent Application Publication
(10) Pub. No.: US 2016/0008816 A1
(43) Pub. Date: Jan. 14, 2016

(54) GAS SPRING BIASED ACCESS COVER FOR MATERIAL HANDLING ATTACHMENTS

(71) Applicant: GENESIS ATTACHMENTS, LLC, Superior,, WI (US)

(72) Inventors: Chad WOOD, Duluth, MN (US); Daniel J. RAIHALA, Superior, WI (US)

(73) Assignee: Genesis Attachments ,LLC

(21) Appl. No.: 14/777,295

(22) PCT Filed: Mar. 15, 2013
(86) PCT No.: PCT/US2013/032579

§ 371 Date: Sep. 15, 2015

(51) Int. Cl. B02C 1/02; E05F 15/53

(52) U.S. Cl. CPC B02C 1/02; E05F 15/53

(57) ABSTRACT

A gas spring biased access cover for a material handling attachment. The gas spring biased access cover having a cover plate sized to substantially cover an access opening in a top plate of the main body of the material handling attachment. The cover plate is pivotally movable between a closed position in which the access opening is substantially covered and an open position in which the access opening is substantially unobstructed by the cover plate. At least one gas spring biases the cover plate in the open position. An access cover fastener secures the cover plate in the closed position.

Material handling attachments, such as demolition shear attachments, concrete crusher attachments, and the like, adapted to attach to the boom or stick of an excavator, typically include an access opening in the main body of the attachment to permit the installation, removal, maintenance and repair of the hydraulic actuator and other components of the hydraulic system which are otherwise enclosed and protected within the main body. The access openings are covered by cover plates which are bolted in place to protect the hydraulic system from falling debris or from damage while the attachment is being manipulated around the material being handled or demolished. The cover plates can exceed 100 pounds or more depending on the size of the access opening and the thickness of the steel used for the cover plate. Accordingly, two people are typically required to lift and remove the cover plate and to replace the cover plate whenever it is necessary to access the hydraulic system of the attachment.

Some material handling attachments are so large that step ladders are often required to reach the cover plates. Thus, it should be appreciated that attempting to handling the heavy cover plates by two people while ascending or descending a ladder is not only awkward and very difficult, but can pose a risk of serious injury if a worker falls from the ladder while carrying the cover plate, or worse if the cover plate were to fall on a worker.

In addition to the foregoing difficulties and concerns with handling heavy cover plates, it is not uncommon for the bolts securing the cover plates in place to unthread due to vibrations while the material handling attachment is being operated. The vibration of the material handling attachment coupled with loose or loosening bolts can cause the cover plates to shake, which not only creates incredible noise, but it can cause the bolts to more quickly unthread or shear off either from the vibration of the cover plate or due to additional stress created on the loose bolts from strain on the cover plate caused by the main body of the material handling attachment flexing or twisting under loads during operation.

Accordingly, there is a need for an access cover for material handling attachments which overcome the foregoing problems.

### DESCRIPTION OF THE DRAWINGS

FIG. 1 is a perspective view of one embodiment of a material handling attachment showing the access cover in the top plate in the closed or shut position.

FIG. 2 is a perspective view of the material handling attachment of FIG. 1 showing the access cover in a partially raised or open position.

FIG. 3 is a side elevation view of the material handling attachment of FIG. 1 showing the access cover in the fully raised or open position.

FIG. 4 is an enlarged perspective view of the access cover shown in FIG. 1 in the closed position.

FIG. 5 is an enlarged perspective view of the access cover shown in FIG. 2 in the partially raised position.

FIG. 6 is an enlarged perspective view of the access cover in the partially raised position as in FIG. 5 viewed in the opposite direction looking toward the rearward end of the material handling attachment.

FIG. 7 is an enlarged partial cross-sectional view of the access cover as viewed along lines 7-7 of FIG. 4.

FIG. 8 is the same enlarged partial cross-sectional view of the access cover as in FIG. 7 but with the access cover in the partially open position.

FIG. 9 is an enlarged partial cross-sectional view of the portion of the access cover fastener circled in FIG. 7.

### DESCRIPTION

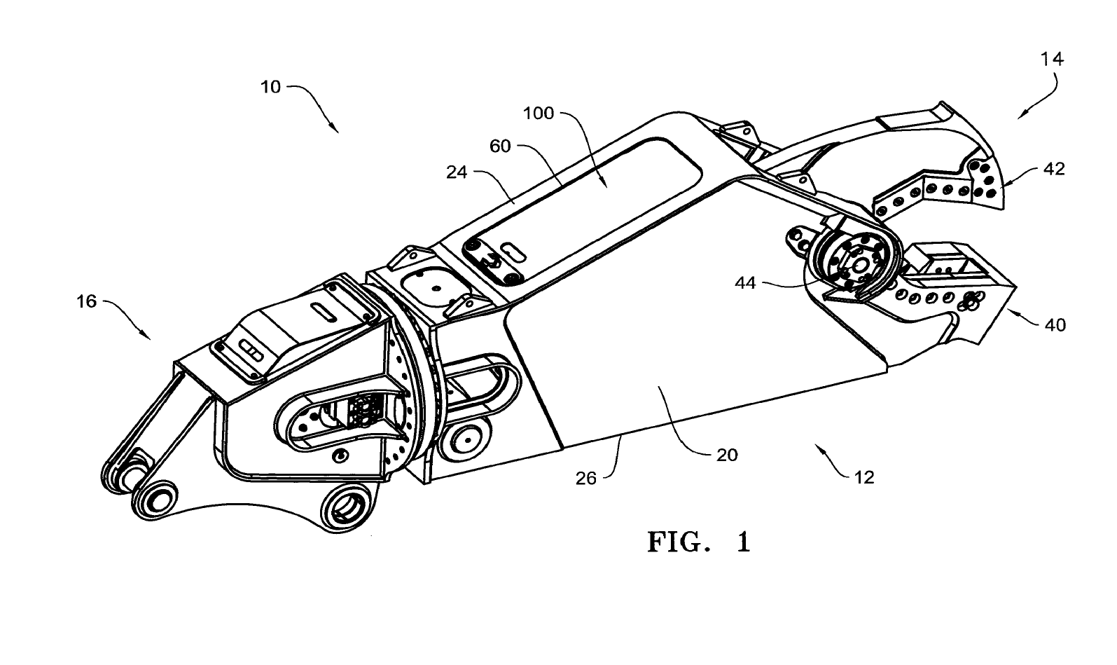

Referring to the drawings wherein like reference numerals designate the same or corresponding parts throughout the several views, FIG. 1 is perspective view of an embodiment of a material handling attachment 10 having a main body 12 with a forward end 14 and a rearward end 16. The rearward end 16 is adapted to be operably mounted to the boom or stick of an excavator (not shown) in the conventional manner as recognized and understood by those of skill in the art. The forward end of the main body 12 operably supports material handling jaws or other material handling elements.

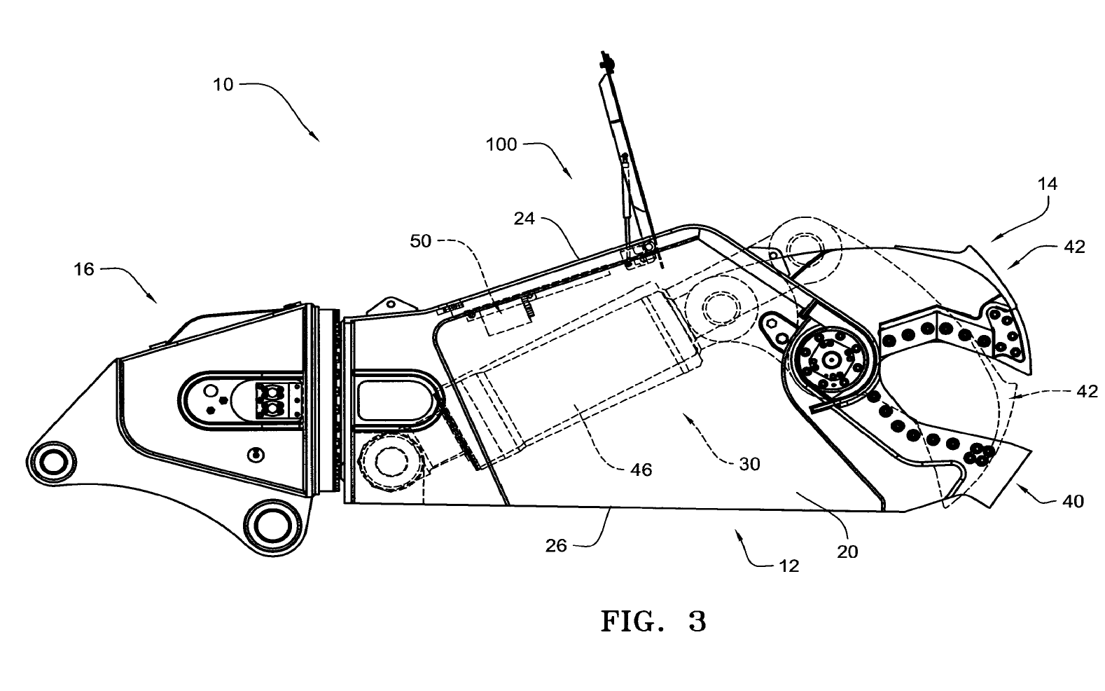

The main body 12 includes side plates 20, 22, a top plate 24 and a bottom plate 26 which together define a substantially enclosed area within which the hydraulic system 30 (FIG. 3) of the attachment 10 is enclosed and protected. In the embodiment illustrated, the attachment 10 is a demolition shear attachment, having a fixed lower jaw 40 and a movable upper movable jaw 42 pivotally supported on the main body 12 by a pivot assembly 44. The upper jaw 42 is movable between an open position and a closed position as illustrated in FIG. 3 by a hydraulic actuator 46 disposed within the main body 12. A hydraulic control valve 50 and hydraulic lines (not shown) are also disposed within the main body 12 of the attachment 10.

The main body 12 of the attachment 10 includes an access opening 60 positioned and sized for installation, removal, repair and/or maintenance of the hydraulic actuator 46, the hydraulic lines and the hydraulic control valve 50 disposed within the main body 12. An access cover 100 is provided to substantially cover the access opening 60 to enclose and protect the hydraulic system.

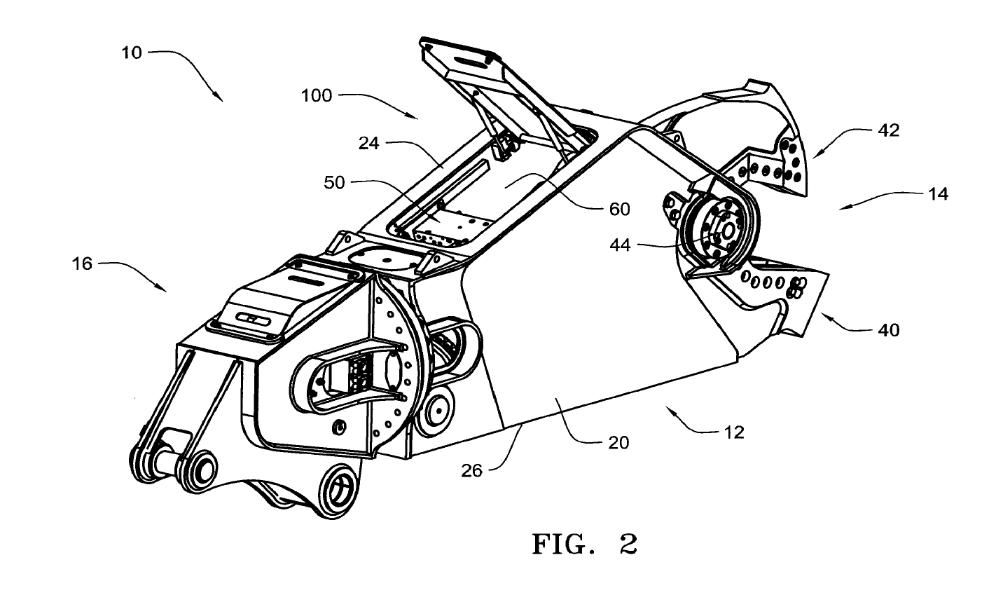

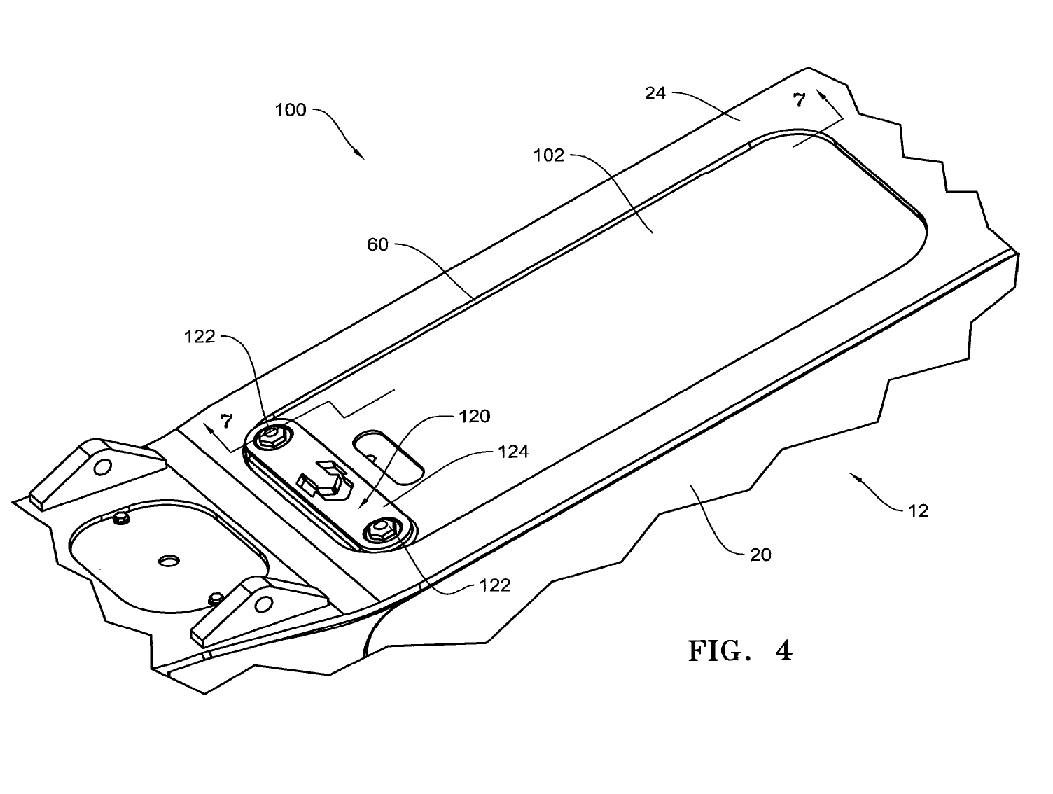

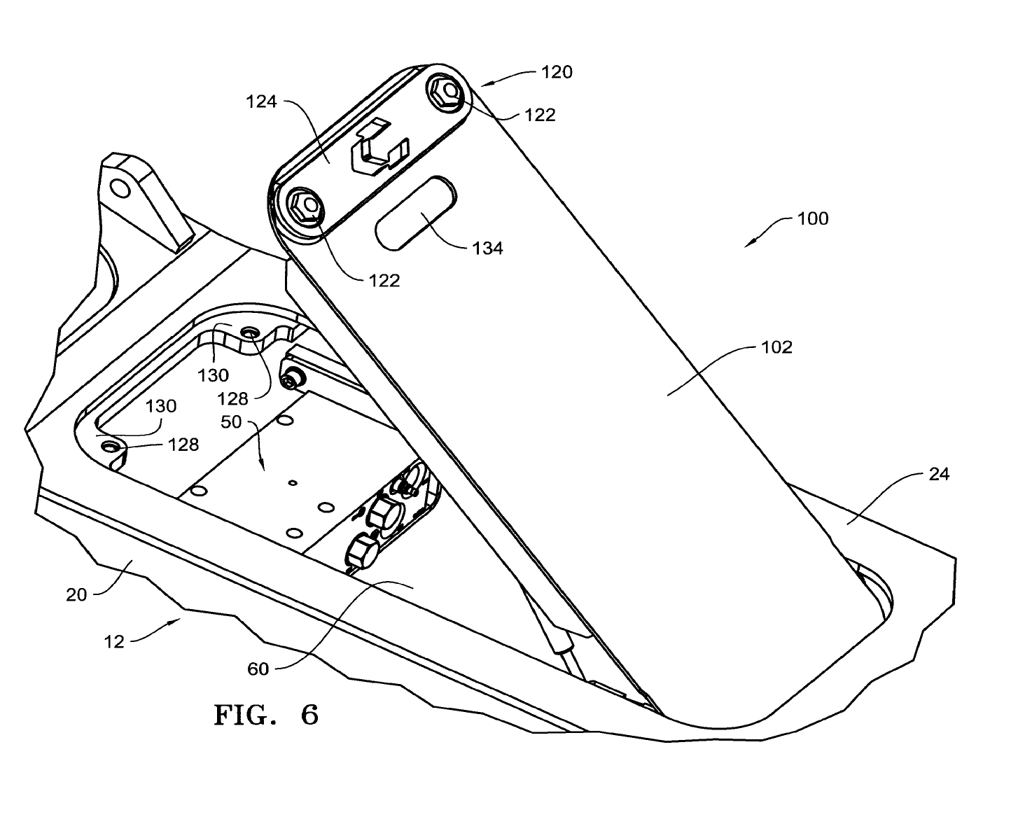

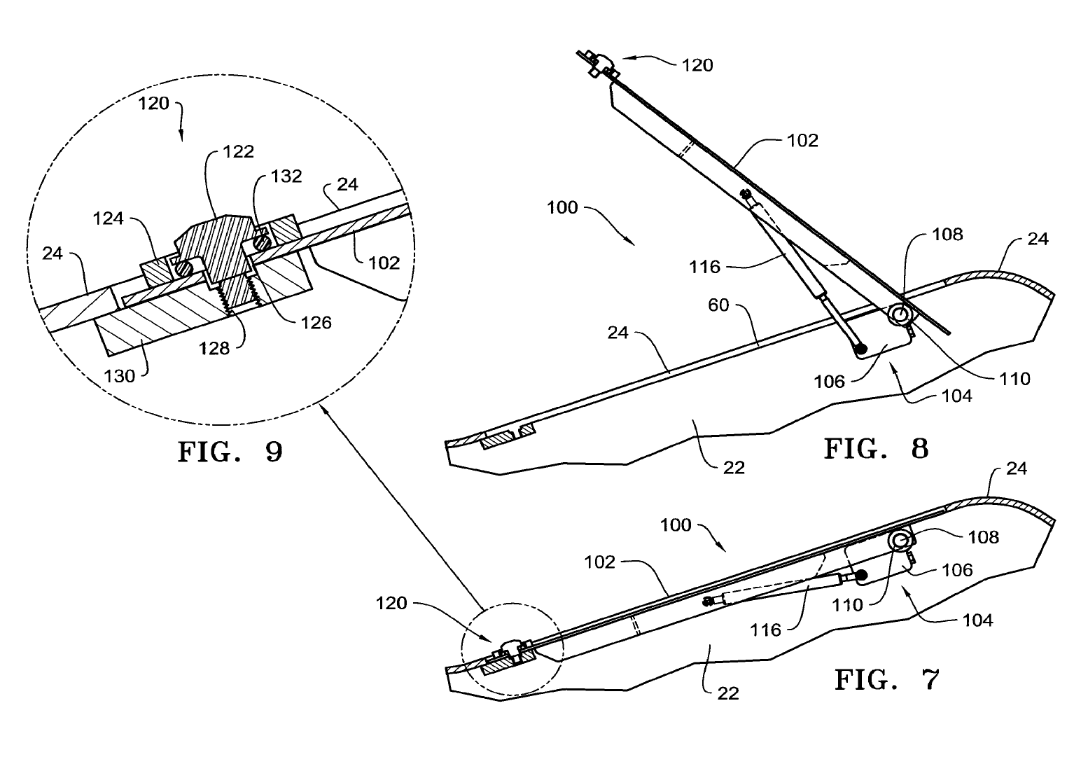

The access cover 100 includes a cover plate 102 which may be fabricated from plate steel or other suitably rigid, durable and impact resistant material. The cover plate 102 is pivotally attached to the main body 12 at or near one end such that the cover plate is movable between a closed position (see FIGS. 1, 4 and 7) and an open or raised position (see FIGS. 2, 3, 5, 6 and 8). When in the closed position, the cover plate 102 substantially covers the access opening 60 to protect the hydraulic system from debris or damage during operation of the material handling attachment. When in the open position, the cover plate 102 is sufficiently open or raised such that the access opening is substantially unobstructed by the cover plate to permit easy access to the hydraulic system components for maintenance and repair. In one embodiment, the cover plate is sized to be received within an interior periphery of the access opening 60 such that a top surface of the cover plate is substantially flush with a top surface of the top plate 24 or slightly recessed below the top surface of the top plate 24.

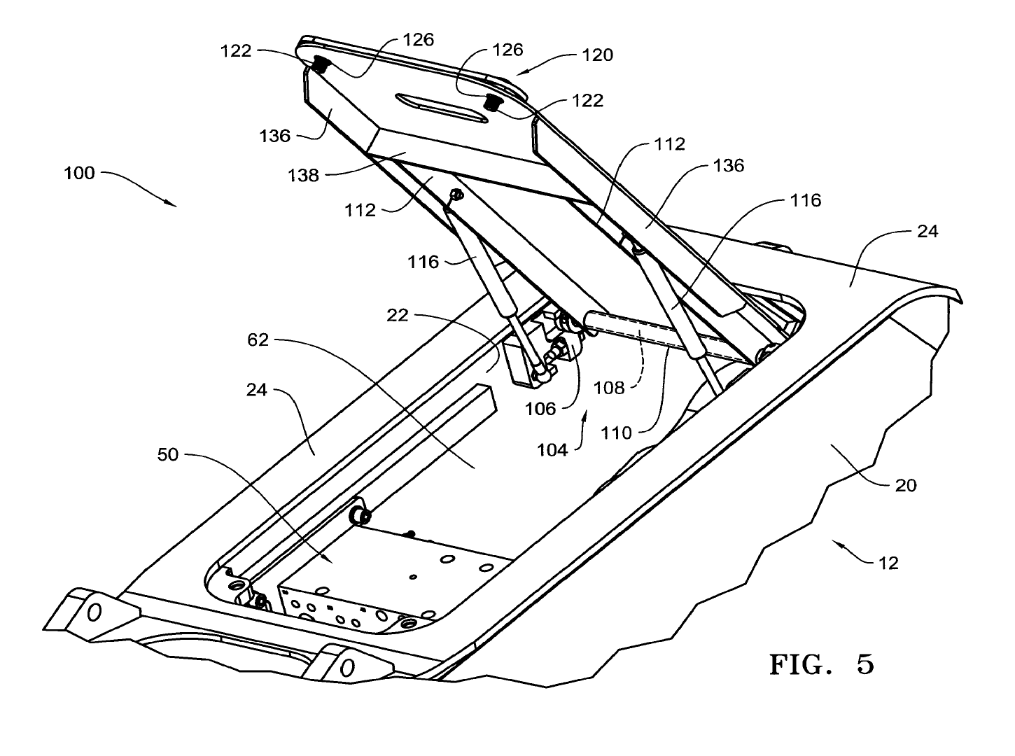

In one embodiment, as best illustrated in FIGS. 5 and 8, the cover plate 102 is pivotally attached to the main body 12 by a hinge assembly 104 disposed below the cover plate 102 and within the access opening 60 so that no portion of the access cover 100 or hinge assembly 104 projects above the top surface of the top plate 24 which could otherwise get hooked or impacted by debris or material during operation of the material handling attachment which could either damage the access cover or cause the access cover to be torn off, undesirably exposing the hydraulic system components to potential damage. In one embodiment, the hinge assembly 104 is disposed rearwardly of the forward most end of the access opening 60 and the cover plate 102 such that when the cover plate is pivoted to the open position, the forward most end of the cover plate 102 pivots into the access opening 60 as best illustrated in FIGS. 6 and 8.

As best viewed in FIG. 5, the hinge assembly 104 includes a pair of hinge brackets 106 are secured below the top plate 24 on opposing sides of the access opening 60. The hinge brackets 106 support a hinge rod 108 which extends through sleeve 110 supported by downwardly projecting flanges 112 proximate each side of the cover plate 102. One or more gas springs 116 are provided to aid in lifting or raising the cover plate 102 by biasing the cover plate in the open position. The gas springs 116 are secured at one end within the access opening 60 to a respective hinge bracket 106 and at their opposite ends to the downwardly projecting flanges 112 of the cover plate 102. The number, size and type of gas springs may depend on the lift angle, the mass of the cover plate, the amount of stroke needed to raise the cover plate to the desired height, the desired lifting and closing effort and other considerations recognized by those of skill in the art.

To retain the cover plate 102 in the closed position, the access cover 100 includes an access cover fastener 120. In one embodiment, as best viewed in FIGS. 6 and 9, the access cover fastener 120 comprises a pair of shoulder bolts 122 received within a retainer 124. The threaded end of the shoulder bolts 122 project through apertures 126 in the cover plate 102 and are threadably received by mating threaded apertures 128 in support plates 130 secured below the top plate 24 within the access opening 60 opposite the hinged end. An O-ring 132 is disposed below each shoulder bolt 122. The O-rings 132 serve to dampen vibration of the shoulder bolt during operation of the material handling attachment 10. By dampening vibrations, the O-rings 132 reduce the tendency of the shoulder bolts 122 to unthread during operation of the material handling attachment. The O-rings 132 also permit the cover plate 102 to slightly flex or twist during operation of the material handling attachment 10 thereby reducing the tendency for the bolts to shear off due to stress on the bolts caused by strain exerted on the main body 12 of during operation of the material handling attachment. A hand grip opening 134 may be provided in the cover plate 102 to assist in lifting or raising the cover plate after removing the shoulder bolts 124 or to assist in pulling the cover plate down from the open or raised position. Side flanges 136 and gussets 138 may be welded to the underside of the cover plate 102 to provide additional structural rigidity to the cover plate 102.

Although a demolition shear attachment is illustrated in the drawing figures and is specifically referred to throughout this specification, it should be understood that the term “material handling attachment” as used herein and in the claims refers to and includes any type of material handling attachment, including, but not limited to, demolition shear attachments, concrete crushers, grapples, buckets, and the like.

The foregoing description is presented to enable one of ordinary skill in the art to make and use the invention and is provided in the context of a patent application and its requirements. Various modifications to the embodiments described herein, and the general principles and features of the embodiments described herein will be readily apparent to those of skill in the art. Thus, the present invention is not to be limited to the embodiments described herein and illustrated in the drawing figures, but is to be accorded the widest scope consistent with the spirit and scope of the appended claims.

1. A material handling attachment, comprising:
a main body having side plates, a top plate and a bottom plate defining a substantially enclosed area, said main body having a forward end and a rearward end, said rearward end capable of being operably attached to a boom or stick of an excavator, said forward end operably supporting material handling elements;
a hydraulic actuator disposed within said substantially enclosed area of said main body;
an access opening in said top plate, said access opening sized and positioned to be capable of installing and removing the hydraulic actuator through said access opening;
an access cover comprising a cover plate, said cover plate pivotally movable between a closed position in which said access opening is substantially covered and an open position in which said access opening is substantially unobstructed by said cover plate, said access cover including at least one gas spring operably secured at one end within said access opening and operably secured at another end to said cover plate, said at least one gas spring biasing said cover plate in said open position, said access cover further including an access cover fastener for securing said cover plate in said closed position.

2. The material handling attachment of claim 1 wherein said cover plate is received within an interior periphery of said access opening.

3. The material handling attachment of claim 1 wherein said cover plate is recessed below a top surface of said top plate of said main body.

4. The material handling attachment of claim 1 wherein a forward most end of said cover plate pivots into said access opening when said cover plate is moved from said closed position to said open position.

5. The material handling attachment of claim 1 wherein said access cover further comprises a hinge assembly, said hinge assembly disposed below said cover plate and interior of said access opening.

6. The material handling attachment of claim 5 wherein said hinge assembly is rearward of a forward most end of said cover plate.

7. The material handling attachment of claim 1 wherein said access cover fastener comprises a shoulder bolt threadably received in mating threaded apertures to secure said cover plate in said closed position.

8. The material handling attachment of claim 2 wherein access cover fastener further comprising an O-ring disposed between each of said shoulder bolts and said cover plate.

9. A gas spring biased access cover for a material handling attachment, comprising:
a cover plate sized to be received within an interior periphery of an access opening in a top plate of a main body of a material handling attachment capable of being operably attached to a boom or stick of an excavator, said main body substantially enclosing a hydraulic actuator, said access opening sized and positioned to be capable of installing and removing the hydraulic actuator through said access opening, said cover plate pivotally movable between a closed position in which said access opening is substantially covered and an open position in which said access opening is substantially unobstructed by said cover plate;
at least one gas spring biasing said cover plate in said open position;
an access cover fastener for securing said cover plate in said closed position.

10. The gas spring biased access cover of claim 9 wherein said cover plate is recessed below a top surface of said top plate of said main body.

11. The gas spring biased access cover of claim 9 wherein a forward most end of said cover plate pivots into said access opening when said cover plate is moved from said closed position to said open position.

12. The gas spring biased access cover of claim 9 further comprises a hinge assembly, said hinge assembly disposed below said cover plate and interior of said access opening.

13. The gas spring biased access cover of claim 12 wherein said hinge assembly is rearward of a forward most end of said cover plate.

14. The gas spring biased access cover of claim 9 wherein said access cover fastener comprises a shoulder bolt threadably received in mating threaded apertures to secure said cover plate in said closed position.

15. The gas spring biased access cover of claim 14 wherein access cover fastener further comprising an O-ring disposed between each of said shoulder bolts and said cover plate.
